(19) United States
(12) Patent Application Publication
(10) Pub. No.: US 2004/0083120 A1
(43) Pub. Date: Apr. 29, 2004

(54) Managing and accounting for shipping structures

(76) Inventor: J. David Sandoval, Spring Grove, IL (US)

Correspondence Address: NATH & ASSOCIATES PLLC, Sixth Floor, 1030 15th Street, N.W., Washington, DC, 20005, US

(21) Appl. No.: 10/658,740

(22) Filed: Sep. 10, 2003

Related U.S. Application Data
(60) Provisional application No. 60/413,616, filed on Sep. 25, 2002.

(51) Int. Cl. G06F 17/60

(52) U.S. Cl. 705/1

(57) ABSTRACT

The present inventive subject matter relates to processes for managing and accounting for shipping structures. In a particular aspect, the present inventive subject matter relates to the buying, using and selling of pallets in the chain of commerce.

### RELATED APPLICATIONS

This application claims the benefit of U.S. Provisional Patent Application No. 60/413,616, filed Sep. 25, 2002, the contents of which are incorporated herein by reference.

### FIELD OF THE INVENTION

The present inventive subject matter relates to processes for managing and accounting for shipping structures. In a particular aspect, the present inventive subject matter relates to the buying, using and selling of pallets in the chain of commerce.

### BACKGROUND OF THE INVENTION

Various types of reusable shipping structures are used to move goods through the chain of commerce. Examples of such structures are various types of shipping pallets, including those made of wood and plastic. Other examples include various types of crates used to transport liquid containers, and tote boxes designed for the transport of a particular type of goods. Being reusable, all of these shipping structures have an intrinsic value as they move through the chain of commerce. For example, shipping structures may move from the manufacturer of the structure to a business user, which places goods on or in the structure. Next, the shipping structure may move to a transportation service, “shipper”, or “carrier”, then to a distributor, user or seller of the goods. Finally, the structure may proceed to a recycler, which may repair the structure and resell them. The business user, which places goods on or in the structure, must purchase the structure from a structure manufacturer or structure recycler. Thus, when the goods are shipped on the structure, the business user passes both the structure and its value on with the goods. Several arrangements or accounting procedures have been developed to assure that a party having paid for a structure is compensated for its value when it leaves that party's possession.

For example, with regards to pallets, one such arrangement is such that the pallets are moved through the chain of commerce on an “exchange” basis and is known throughout the industry as “pallet exchange”. Pallet exchange is a process that involves trucking companies as well as shippers, such as consumer product manufacturing companies, and receivers, such as distributors. When a trucking company or other carrier arrives at the shipper's dock to pick up a shipment of products, the truck has empty pallets on board to exchange for the pallets loaded with product being shipped. That is, when a transportation service picks up goods on pallets from a manufacturer for delivery to a distributor, the transportation service is expected to deliver to the manufacturer the same number of empty pallets as it picks up with goods. Similarly, when the carrier delivers the shipment to a distributor, the distributor is to provide pallets to the carrier in exchange for the pallets under product.

This practice has been a problematic process in the supply chain for many years, and has been the target of many industry studies and improvement efforts. These efforts over the years have not been very successful. Particularly problematic is the fact that this arrangement causes the transportation service or other carrier to transport empty pallets, and to be responsible for them. Carriers have thus been “stuck in the middle” of the exchange problem, and as a result, the process has added significant cost to carrier operations, which causes upward pressure on freight rates and/or accessorial charges. Further, unless each party receiving pallets is watchful of the condition of the pallets it receives, it may accumulate damaged or poor quality pallets which are refused in an attempted exchange.

This is particularly true in the Food and Consumer Products Industries where the primary shipping platform utilized for transporting products though the supply chain is the Grocery Manufacturers Association (“GMA”) 40″×48″, 4-way wooden pallet. Most major channels of distribution, for example: Grocery, Mass Merchants, Food Service, Convenience Stores and Drug Stores, use this type of pallet. Accordingly, poor pallet quality, record keeping problems, and inconsistent standards/expectations of the trading partners involved have all contributed to a general opinion that the “pallet exchange” process does not work.

In an alternate arrangement used with wood pallets, ownership of the pallets remains with the supplier of the pallets. One particularly well-known supplier in the industry is CHEP USA. In this process, the supplier rents or leases the pallets to a user, such as a manufacturer. The manufacturer, then transfers the rented or leased pallets to a transportation company when goods are shipped on the pallet. Similarly, when the pallets with goods thereon are delivered to a distributor, the rented or leased pallets are transferred from the transportation company to the distributor. The supplier of the pallets recovers the pallets from the distributor and reconditions them if necessary for further use. The user of the pallets is charged a rental or lease fee for each pallet. Further, an accounting system is established to track the movement of the rented or leased pallets from user to transportation company to distributor. While this arrangement eliminates the exchange process, reduces carrier costs, and eliminates poor pallet quality problems, it is very costly to the manufacturer. The lease or rental fee to the manufacturer must cover the cost of the pallets and their maintenance, as well as the cost of picking up the empty pallets from a distributor, and delivering new or reconditioned pallets to the manufacturer.

Major trade associations in the industry have sponsored efforts to study the pallet problem and make recommendations for improvement. In the early 1990's the GMA organized a Pallet Subcommittee to the Distribution Committee, to study the pallet problem. A report was published in 1992, highlighting the various issues/causes contributing to the problems with the exchange program, and offering recommendations for improvement. This report was focused on pallet design, pallet performance requirements, and the overall pallet quality issue. The report referenced the pallet rental programs as an alternative that could have a positive impact on the poor quality problem. The report also provided evaluation templates for companies to assess their pallet programs.

In 1995, the Efficient Consumer Response (“ECR”) Initiative, sponsored by the GMA and several other trade associations, published a Transportation Report, including recommendations on pallets. This report recommended the elimination of the pallet exchange process, and highlighted rental programs and one-way, low-cost, corrugated platforms as viable alternatives. Plastic pallets were also referenced as an alternative, but limited to closed-loop applications due to high unit cost.

In January 2000, the Efficient Foodservice Response (“EFR”) Initiative, similar to ECR but for the Food Service channel, conducted an industry survey and published a report titled “Assessing Pallet Cost in Food Service”. This report included survey results, and recommendations for the industry. Major survey findings can be summarized as follows:

1. Pallet exchange continues to be the most prevalent practice, with 70% of shippers and 96% of distributors with active programs.

2. Inventory control is the most challenging aspect of pallet management for shippers.

3. Pallet quality is the biggest challenge facing distributors.

The report recommendations included:

1. Full and open disclosure between trading partners to improve pallet quality and reduce costs.

2. Adopt self-regulation programs or 3^{rd} party programs to further improve pallet quality.

3. Adopt published industry guidelines/specifications for pallet construction.

4. Determine the most cost-effective platforms, considering all relevant and significant cost factors across the entire supply chain.

These studies not only illustrate the problems with the exchange process, but also that these problems persist, and that viable alternative solutions are difficult to identify and implement. These studies also validate that while the rental concept has gained significant share, program costs are a barrier to broader acceptance.

Accordingly, there remains a need in the art for a process that eliminates the poor quality shipping structure problem that is associated with “pallet exchange”, while reducing the shipping costs and simplifying the shipping process for the manufacturer. The present inventive subject matter addresses these needs.

### SUMMARY OF THE INVENTION

The present inventive subject matter relates to a method of administering the cyclic use and movement of one or more reusable shipping structures comprising:

a. a first party providing one or more empty reusable shipping structures to a second party at a first value x;

b. said second party placing materials on said one or more reusable shipping structures; and

c. a third party purchasing said one or more reusable shipping structures with materials thereon from said second party at a second value y;

wherein said second value y is less than said first value x.

### BRIEF DESCRIPTION OF THE DRAWINGS

FIG. 1 is a flowchart that shows the movement of the shipping structure(s) throughout the chain of commerce. A “First Party” transfers a shipping structure to a “Second Party” at value x; the “Second Party” transfers the shipping structure to a “Third Party” at value y; the “Third Party” uses the shipping structure and then transfers the shipping structure to a “First Party”.

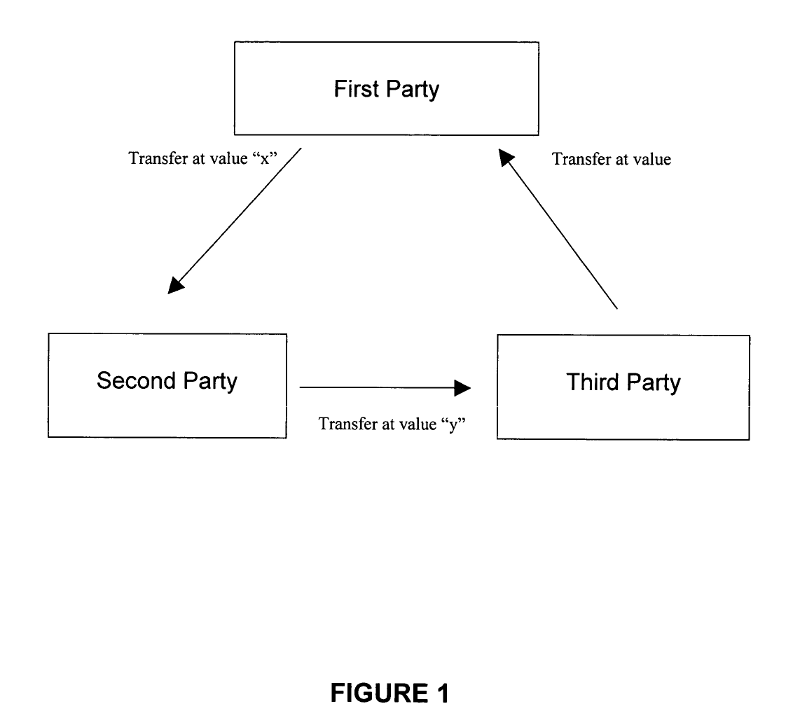

FIG. 2 is a flowchart that shows the movement of the shipping structure(s) throughout the chain of commerce. A “First Party” transfers a shipping structure to a “Second Party” at value x; the “Second Party” transfers the shipping structure to a “Third Party” at value y via a “Fourth Party” shipper or carrier; the “Third Party” uses the shipping structure and then transfers the shipping structure to a “First Party”.

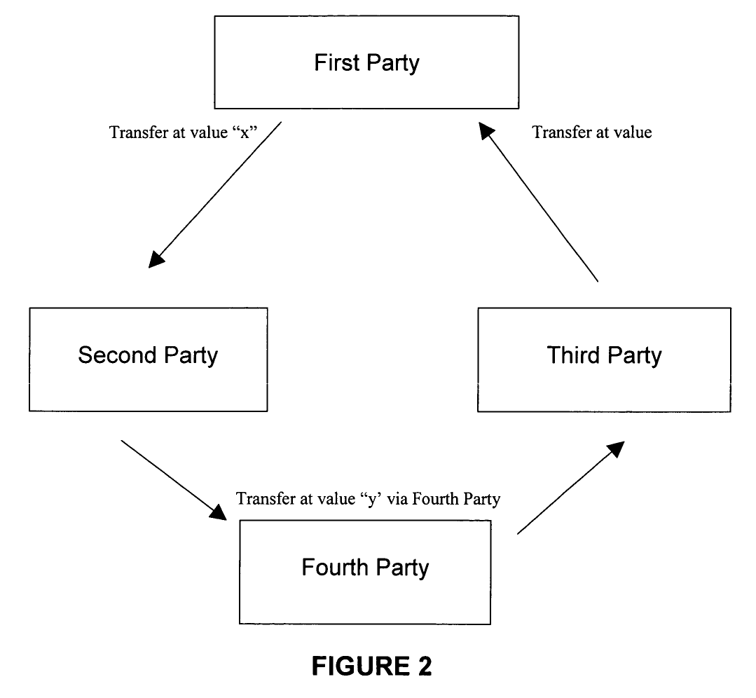

### DETAILED DESCRIPTION OF THE INVENTION

Buying and selling are among the most basic standard operating procedures for every manufacturer and distributor. Pallet exchange programs and pallet rental programs are not well managed programs due to the unusual nature of the transactions involved, and the inherent pallet inventory management problems.

The applicant has devised a new method for handling the flow of reusable shipping structures through the chain of commerce at reduced cost and with a simplified arrangement for accounting for the value of the shipping structures as they move through the chain of commerce. While the applicant's method is applicable to a wide range of reusable shipping structures, it is exemplified with reference to pallets.

The applicant's new method, which eliminates the exchange process, transfers ownership of a pallet from a first party, or supplier of the reusable shipping structure to a second party, or manufacturer, who uses the reusable shipping structure internally and then sells the shipping structure with the product to a third party, or distributor. The third party, or distributor, uses the shipping structure, then sells the shipping structure to a shipping structure recycler, who repairs the shipping structure if needed, then sells the shipping structure back to a manufacturer for the next “cycle”. This manufacturer, of course, may or may not be the original owner of the shipping structure.

In one embodiment, the present inventive subject matter relates to a method of administering the cyclic use and movement of one or more reusable shipping structures comprising:

a. a first party providing one or more empty reusable shipping structures to a second party at a first value x;

b. said second party placing materials on said one or more reusable shipping structures; and

c. a third party purchasing said one or more reusable shipping structures with materials thereon from said second party at a second value y;

wherein said second value y is less than said first value x.

In a preferred embodiment, the first value x is about equal to that of a new or fully reconditioned reusable shipping structure. In a further preferred embodiment, the shipping structure is a pallet. A second party, usually a product manufacturer, buys the pallet and charges its internal operations a usage fee which is about equal to the difference between the first value x and the second value y, for each pallet put in use. This usage fee is attractive to the manufacturer because it is cheaper than the shipping costs borne under a rental program such as CHEP and is easier to administer.

After the pallet is used by the second party, the second party sells the pallet to a third party “under product”, i.e. under the product that the second party is selling to the third party, for a second value y. The second value y, in order to be attractive to the third party, is preferably less than or equal to 90% of the value of x. In a most preferred embodiment, the second value y is about equal to 60% of the value of x. After the third party is finished using the shipping structure, it sells the empty reusable shipping structure. The third party, which purchased the shipping structure for a value of y, may sell the shipping structure for less than the value of y, more than the value of y, or for an amount about equal to the value of y.

Like the rental concept, the present invention eliminates the exchange process, thus achieving the reduced carrier cost benefit. The present invention also provides several additional benefits that the rental program does not.

One such benefit is that the applicant's method allows manufacturers to purchase pallets to a particular specification in a competitive environment. Many pallet suppliers and recyclers are in the marketplace capable of providing pallets. In a rental program competition is virtually nonexistent, creating an environment that gives excessive leverage to the program provider, which drives the manufacturer's costs up. In addition to cost, the resulting pallet quality and supplier service performance can also be managed effectively in a competitive environment.

Another such benefit is that with the applicant's method, pallets are treated just like any other raw material or supply item that is purchased for production. When the pallets are used to move product from production into finished goods inventory available for sale, the pallet becomes a product for sale as well. Customer orders include pallets as an item on the order, in quantities appropriate to handle the regular items on the order. Treating pallets as a product to be sold just like any other product creates continuity in business processes, eliminating the need for unique processes for pallet management.

The inventive method yields a further benefit because treating pallets like a product also creates opportunity for unique specifications that may be suitable for specific applications. Trying to make “one size fits all” an industry standard, which is needed for an exchange program to work, is not necessary in the applicant's method. With the transfer of ownership through the supply chain, normal market dynamics will drive the development of specific value-added designs. One example is plastic pallets. Plastic pallets have not been widely utilized due to the high price per unit. The only successful applications have been in “closed loop” systems where the pallet inventory can be controlled to limit disappearance. With the applicant's method, as ownership transfers through the supply chain, managing the inventory of plastic pallets becomes a normal standard operating procedure for each company, reducing the concern about high initial cost.

Yet a further additional benefit is that the third party may actually make a profit on the sale of the pallet. For example, if the pallet is not damaged prior to its sale, the third party, i.e. distributor, may get a higher price for the pallet than was originally paid for the pallet, value y, when she bought the pallet from the second party, i.e. the manufacturer.

The applicant's method will typically involve computer programs to physically track the pallets and to record and transfer their value as they are moved through the chain of commerce. In addition, it will be possible to track, and we expect, to reduce damage to pallets by determining where damage occurs and invoicing the responsible party.

For example, the manufacturer which uses the pallets during the course of manufacturing products and preparing them for shipment will have a computer programmed to define the pallets needed, and accepted sources of those pallets, to meet its production requirements. The computer program will maintain an inventory of the pallets as a raw material or supply item and will transfer them to internal operations when put in use. An internal usage fee will be charged to the internal operations. When the pallets are transferred into finished goods inventory with goods thereon, they will be valued in the finished goods inventory at their purchase price less the usage fee. When a pallet of goods is sold to a distributor, the goods and pallet are invoiced as separate items. The distributor also may have a computer program to keep track of pallets purchased and the value thereof, and of pallets sold and the price realized.

### EXAMPLES

The following examples are illustrative of the present invention and are not intended to be limitations thereon.

### Example 1

A product manufacturer defines pallet specifications and qualifies suppliers of new and reconditioned pallets. The manufacturer buys 10,000 pallets at a cost of $5.00 per pallet to support production and shipping demand. After purchase, the pallets are inventoried as a raw material or supply item and issued as needed. The manufacturer charges the internal operation a “usage fee” of $2.00 for use of each pallet. This fee is established by the anticipated selling price of $3.00 to potential customers. The purchase price, $5.00, less selling price, $3.00, equals the usage fee of $2.00.

The pallets are then transferred into finished goods inventory and assigned a product code for sale to customers. The pallets are valued in finished goods inventory at $3.00, which represents the purchase price, $5.00, less the usage fee of $2.00.

The distributor, or customer, buys 500 pallets “under product purchased” for $3.00 each. The distributor then uses the pallets internally, and accumulates extra pallets for resale to a pallet recycler. The distributor sells pallets to recycler for $3.00, thus recovering initial “cost” of $1500.00.

The pallet recycler purchases 500 pallets from the distributor at $3.00 each. The recycler then sorts and repairs pallets as needed, and deploys inventory as needed. The recycler then sells the reconditioned pallets back to the manufacturer at a cost of $5.00 per pallet.

### Example 2

A manufacturer buys 10,000 pallets at a cost of $5.00 per pallet to support production and shipping demand. After purchase, the pallets are inventoried as a raw material or supply item and issued as needed. The manufacturer charges the internal operation a “usage fee” of $2.25 for use of each pallet. This fee is established by the anticipated selling price of $2.75 to potential customers. The purchase price, $5.00, less selling price, $2.75 equals the usage fee of $2.25.

The pallets are then transferred into finished goods inventory and assigned a product code for sale to customers. The pallets are valued in finished goods inventory at $2.75, which represents the purchase price, $5.00, less the usage fee of $2.25.

The distributor, or customer, buys 500 pallets “under product purchased” for $2.75 each. The distributor then uses the pallets internally, and accumulates extra pallets for resale to a pallet recycler. The distributor sells pallets to recycler for $3.25 per pallet, thus recovering initial “cost” of $1375.00 and making an additional $250.00.

The pallet recycler purchases 500 pallets from the distributor at $3.25 each. The recycler then sorts and repairs pallets as needed, and deploys inventory as needed. The recycler then sells the reconditioned pallets back to the manufacturer at a cost of $5.00 per pallet.

The invention being thus described, it will be obvious that the same may be varied in many ways. Such variations are not to be regarded as a departure from the spirit and scope of the invention and all such modifications are intended to be included within the scope of the following claims.

We claim:

1. A method of administering the cyclic use and movement of one or more reusable shipping structures comprising:
a. a first party providing one or more empty reusable shipping structures to a second party at a first value x;
b. said second party placing materials on said one or more reusable shipping structures; and
c. a third party purchasing said one or more reusable shipping structures with materials thereon from said second party at a second value y;
wherein said second value y is less than said first value x.

2. The method of claim 1, further comprising the step of said second party valuing said one or more reusable shipping structures with materials thereon at a second value y.

3. The method of claim 2, further comprising the step of said third party removing the materials from said one or more reusable shipping structures.

4. The method of claim 3, further comprising the step of said third party selling said one or more empty reusable shipping structures.

5. The method of claim 2, wherein a fourth party delivers said one or more reusable shipping structures with materials thereon from said second party to said third party.

6. The method of claim 5, wherein said fourth party is a transportation service carrier.

7. The method of claim 1, wherein said second party charges its internal operations a usage fee which is the difference between the first value x and the second value y, for each reusable shipping structure put in use.

8. The method of claim 1, wherein the first value x is about that of new or fully reconditioned reusable shipping structure.

9. The method of claim 1, wherein the second value y is about sixty percent of the first value x.

10. The method of claim 1, wherein said one or more reusable shipping structures are pallets.

11. The method of claim 10, wherein said pallets are wooden pallets.

12. The method of claim 1, wherein said first party is selected from the group consisting of a shipping structure supplier and a shipping structure recycler.

13. The method of claim 1, wherein said second party is a product manufacturer.

14. The method of claim 1, wherein said third party is a product distributor.

15. The method of claim 1, further comprising said first party reselling one or more empty reusable shipping structures to a second party.

16. The method of claim 4, wherein said third party sells said empty reusable shipping structure for an amount about equal to the second value y.

17. The method of claim 4, wherein said third party sells said one or more empty reusable shipping structure for an amount greater than the second value y.

18. The method of claim 4, wherein said third party sells said one or more empty reusable shipping structure for an amount less than the second value y.
